(19) United States
(12) Patent Application Publication
(10) Pub. No.: US 2008/0304687 A1
(43) Pub. Date: Dec. 11, 2008

(54) Ergonomic Support and Control Harness for Boom Pole Operation

(76) Inventor: Edward Lamar Howell, Orlando, FL (US)

Correspondence Address: Edward Howell, 1584 Providence Circle, Orlando, FL, 32818, US

(21) Appl. No.: 11/759,229

(22) Filed: Jun. 7, 2007

(51) Int. Cl. H04R 17/02

(52) U.S. Cl. 381/362

(57) ABSTRACT

This invention relates generally to film and television production. It is designed to easily control and support a boom pole for long periods of time while allowing the operator to maintain comfortable ergonomic positioning and movement of the head, arm and hands during operation. It achieves this by means of a simple machine. The basic embodiment of the invention consists of five (5) main components. 1. An ergonomically positioned control handle which the operator grips; the boom pole itself (or a holder to which may be fastened in position an existing boom pole), which is rigidly connected to the control handles. 3. A means for pivoting (the fulcrum), or other machine means for transferring force, mounted to a harness, and to which is attached the connecting segment, allowing the boom to rotate and move when force is applied to the control handles. 4. Counterweights which can be fastened to the connecting segment at the farthest point possible opposite the fulcrum from the extended end of the boom pole, and/or mechanisms for fastening such weights. 5. A wearable harness including shoulder straps which can be connected in front, and optionally including a belt around the waist where additional support is required, and to which is mounted, on the back, the pivoting assembly, and the rest of the apparatus. By applying force to the control handle, the operator is able to move the boom pole up and down, side to side, or to rotate it.

### BACKGROUND

1. Field of the Invention

This apparatus relates to the support and positioning of motion picture and recording equipment, specifically microphones.

2. Description of the Prior Art

In motion pictures, such as film and television, a boom is used as a mechanical arm or pole designed to hold equipment on the end, such as a directional microphone. Other terms for a boom are: “boom mike”, “fishpole”, and “giraffe.” During a shot (also called a take, which is a continuous block of unedited film or video) the boom is extended out near the people or objects being filmed. The shot may require the boom pole to be held steadily in place for several minutes, to move with the action of the scene, or to move about within the set, multiple times, in the course of a day's work. The boom operator (also called a “gaffer”) is the crew member responsible for controlling the boom, most commonly a microphone boom, in this manner. The operator must use the boom to position the microphone closely enough to the sound source to capture quality audio, but out of the frame of the camera's view.

There are two main types of support for boom poles in the motion picture industry; studio booms and hand held booms. Studio booms are supported by a vertical pole atop a tripod, wheeled or weighted base. These can be very large and are meant for use with heavy equipment in a studio environment. They can be moved or pivoted around their point of support. Hand held boom poles are entirely supported and positioned by a human operator. They can be held one of two ways. The most common method is for the operator to hold the boom arm over his/her head using both arms, with one arm providing support near the center of gravity, and the other grasping the nearest end. To use the boom from overhead in this manner, the boom must be positioned approximately 16 inches (˜40.5 cm) above the head and extended outward over the scene or action being filmed. The other method is to use the boom from below, holding the near end of the boom pole under the arm, while supporting and positioning it with the same hand. The boom must be positioned downward and extended toward the scene so that the microphone is approximately a foot above the ground.

The mechanism of a boom pole can be replicated with almost any material, such a metal, PVC or wood dowels. However, the stresses and usage requirements mean that the best and more expensive boom poles are manufactured of quality aircraft aluminum, or even carbon graphite fiber. Many also feature padded grips, standardized threaded connectors for assembling multiple pole sections, embedded wiring, and noise-reducing features.

However, despite these supplements, there are several fundamental problems arising from conventional boom pole operation. Holding the boom pole above the head requires not only significant upper body strength, but significant stamina as well. It is common for boom operators to suffer from severely tired arms. FIG. 1 displays the commonly used method of operation of a boom pole 30x in the overhead hand-held position. Although the weight of a microphone 28x at the end of the boom pole is sometimes counterbalanced by a counterweight 50x, the supporting position of the operator's arms, hands and head produces stress 25x. Shots lasting several minutes and repeated shots can impair the operator's ability to keep the boom steady as they hold it above their heads and at an angle for prolonged periods. Since the boom is held parallel to the shoulders, the operator must turn their head to either side in order to see the microphone's placement during the shot.

Holding the boom under the arm can cause further problems, as the pressure against the underarm has the potential to cause loss of blood flow to the supporting arm and hand during prolonged use. FIG. 2 displays the operation of the boom pole from the under-arm position. The microphone 28x is positioned near the ground at the end of the boom pole 30x. The boom pole is supported and balanced in one hand, while the opposite end presses upward against the underarm, producing stress 25x and potentially impairing blood circulation.

Current patents that attempt to solve the multiple problems of boom operation fail to fully address them, especially the necessity to hold the arms above the head. U.S. Pat. No. 6,594,371 discloses “a microphone boom assembly capable of articulation around a pivot point for precise microphone orientation.” However, this sectioned boom arm, unless rested on the ground, still requires the operator to support the entire weight of the assembly with their arms.

U.S. Pat. No. 6,450,377 discloses one approach to reducing arm strain. That patent's background information states that “holding the boom overhead for extended periods is an extremely difficult job” that can even lead to back injuries. The described invention “Gaffer's Harness” is a support for a boom, basically consisting of a harness with two pneumatic cylinders movably mounted to rigid supports in the front and back. The cylinders have on their opposite ends one small movable bracket each which hold the boom arm. However, this still requires the operator to have their hands above their head to stabilize the boom for prolonged periods of time. Also, changes in the angle of the boom arm must be performed by disengaging a toothed coupling, pushing or pulling the boom arm, then re-engaging the coupling. During a shot, the operator cannot easily change the angle of the boom arm.

Another proposed solution is disclosed by ATS Communications on the World Wide Web at http://www.atscomms.com. The inventor, Pascal Coulombier, describes the “Kit Cool microphone boom pole support system” as a device to take the weight of a boom pole off of the hands of the operator. It also comes in a larger model variant called the Cool Cam, designed to support cameras. This device supports the boom via an angled pole seated on its end in a pouch or cup, attached to a belt secured around the operator's waist. The pole is stabilized by straps that encircle the chest, and the boom is positioned parallel to the shoulders. The operator then moves the boom using one or two hands. This device presents many of the same problems as traditional hand held boom pole operation, because at least one hand is held above the head and the head is sharply turned to one side during operation. In addition, the entire weight of the device is pressing down and back into the lower stomach or groin.

A comprehensive search of available products and patents has not yielded any boom support mechanism that combines complete freedom of movement, manipulation and control, which is designed to be used with the operator's arms down and head facing front at all times, and which features a comfortable point of support for its weight. This unsolved problem of boom operators, who are extremely tired from holding boom microphones, is even referenced humorously in commercials and documentaries.

### SUMMARY OF THE INVENTION

This invention is an ergonomic apparatus designed to be worn by a human operator, which will comfortably support a boom pole and attached microphone in position for long periods of time, and enable control and movement of the boom during normal operation, while the operator's body remains within a range of ergonomically correct positions.

### Objects and Advantages

Accordingly, the main object and advantage of my invention is the ability to comfortably support a boom pole for periods of time ranging from a few seconds to hours; while the operator's arms remain down below shoulder level, the upper arms are within 45 degrees of the sides of the body, the elbows are bent less than 90 degrees, and the head is facing forward. The boom pole is positioned with the extended preponderance of the pole directly in front of the operator so that he or she can see it without needing to turn the head significantly to the left or right. Ideally, the head should be centered over the shoulders, with eyes looking straight ahead or just below a horizontal gaze. The shoulders should be down, and the back should be upright. There should be no twisting of the torso. FIG. 3 shows the range of comfortable positions, specifically for the arms, hands and head, which dictated the design of this invention from the beginning.

Another object and advantage of my invention is the point of support, which is not the arms, but the upper body. The weight of the apparatus is supported comfortably and entirely by the operator's torso, by means of a harness which is worn like a backpack. Additionally, the control handle or handles can be adapted to work with left, right, or both hands.

A further advantage is the simplicity of design, construction and operation of the invention. The control over the boom pole's movement is achieved through “simple machines” which apply Newton's Third Law of Motion: muscular force applied to the control handles is transferred into vertical motion of the boom pole. The invention can be translated into several variations of size, complexity and purpose without changing the basic physics involved or the ergonomic position of the operator. The simplicity of the concept allows many parts to be based on prior art, or even well-established engineering concepts. Further objects and advantages of my invention will become apparent from a consideration of the drawings and ensuing description.

### BRIEF DESCRIPTION OF THE DRAWINGS

FIG. 1 is a side view displaying the current non-ergonomic method of hand held boom pole operation from above.

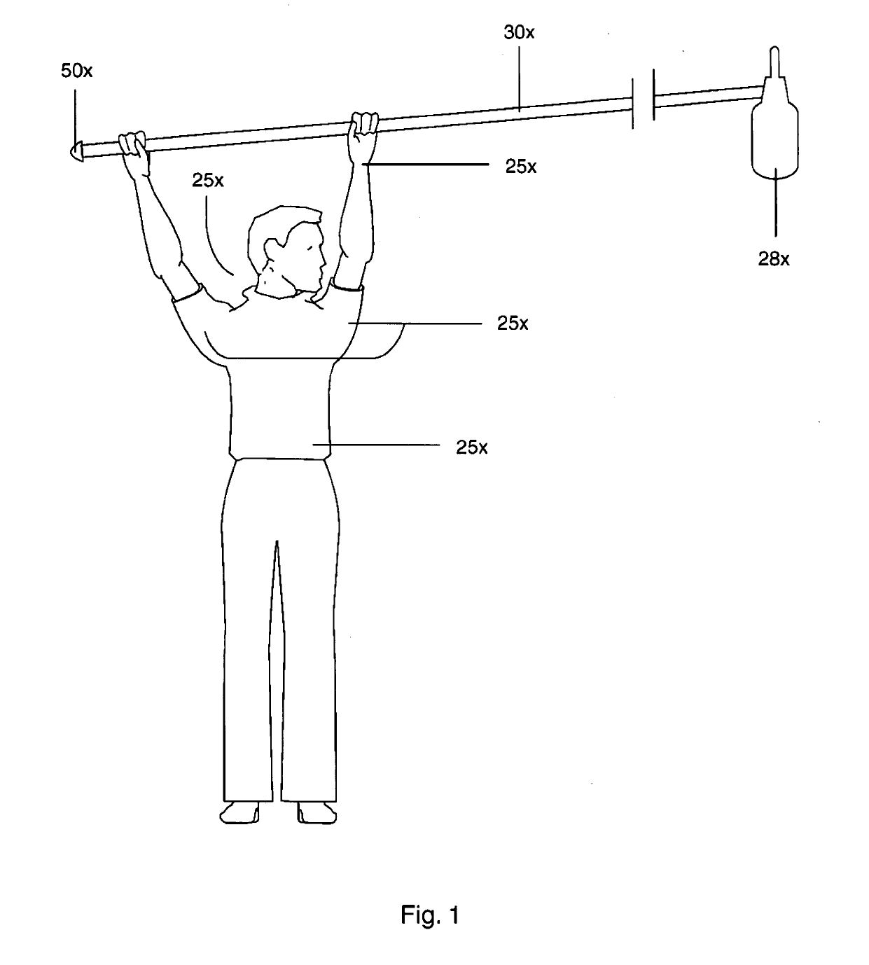

FIG. 2 is a side view displaying the current non-ergonomic method of hand held boom pole operation from underneath.

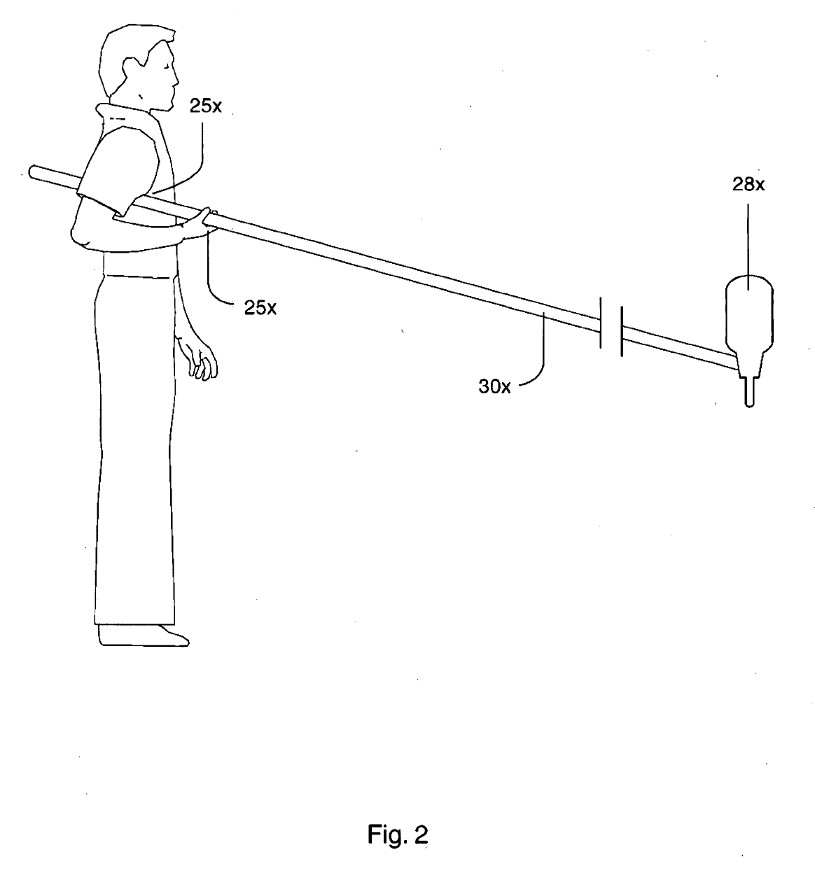

FIG. 3 is a side view showing the desired, improved ergonomic body position and optimal range of motion for the arms and hands.

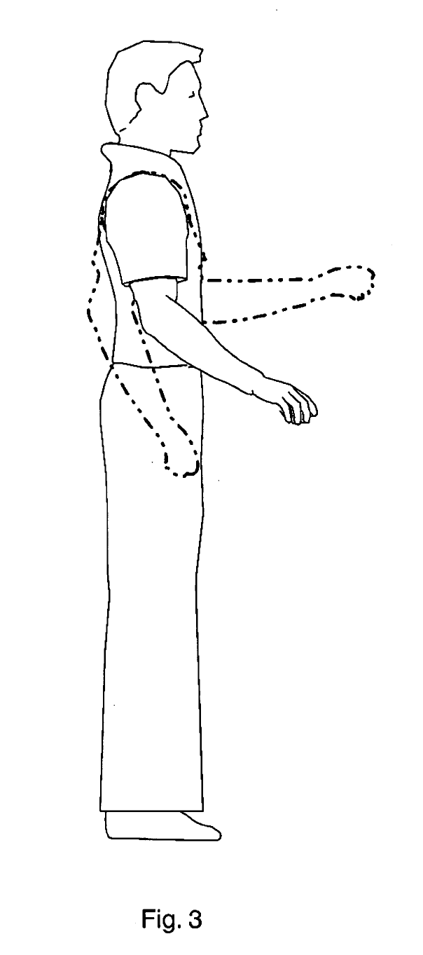

FIG. 4 is a side elevation view of the invention.

FIG. 5 is a perspective view from the front of the invention.

FIG. 6 is a perspective view from the back of the invention.

FIG. 7 is a side elevation view showing the alternate positions of the moving parts.

FIG. 8 is a rear perspective view showing the alternate positions of the user-adjustable components.

FIG. 9 is a perspective view from the front of a modified form of the invention with two control handles, and including a pivot assembly which is mounted on a vertical pole.

FIG. 10 is a perspective view from the back of said two-handle form.

FIG. 11 is a side elevation view showing the alternate positions of the moving parts of the said two-handle form.

FIG. 12 is a rear perspective view of said two-handle form showing the alternate positions of the user-adjustable components.

FIG. 13 is a front perspective view of a modified form of the invention featuring a connecting segment that positions the boom arm below the waist.

FIG. 14 is a rear perspective view of a modified form of the invention featuring a connecting segment that positions the boom arm below the waist.

FIG. 15 is a front perspective view of a modified form of the invention featuring a combination of a lever, and a belt to transfer rotary force from two points on the control handle to the boom arm.

FIG. 16 is a rear perspective view of said modified form of the invention featuring a combination of a lever and a belt.

### LIST OF REFERENCE NUMERALS

Existing Method of Boom Operation

25x Stress Point on Operator

28x Microphone

30x Boom Pole

50x Counterweights

Basic Configuration

28 Microphone

30 Boom Pole

32 Means for attaching the boom pole to the connecting segment 34

34 Adjustable means for connecting the boom pole 30 to the control handle 70

35 Means for supporting the lever machine 40a

40a Means for transferring force from the control handles to the Boom Pole via simple machine, a lever

50 Counterweights

52 Means for attaching counterweights

70 Control Handle

70a Inner telescoping section for adjusting length of control handle part 70

70b Outer telescoping section for adjusting length of control handle part 70

70c Means for locking the adjusting telescoping sections of control handle part 70

74 Handgrip

80 Support Harness

84 Padded Shoulder Straps

Two-handed Embodiment

128 Microphone

130 Boom Pole

132 Means for mounting/attaching the boom pole 130

134 Connecting means, a segment for attaching and adjusting the boom pole 130 to the control handle 170

134a Upper articulating section for connecting segment 134

134b Means for pivotably connecting the articulating sections of connecting segment 134

134c Lower articulating section for connecting segment 134

134d Inner telescoping section for connecting segment 134

134e Means for allowing contraction, expansion, and locking of the telescoping sections of connecting segment 134

134f Outer telescoping section for connecting segment 134

135 Means for supporting the machine part(s) 140a upon the Support Harness 180

135a Inner telescoping section for adjustment part 135

135b Outer telescoping section for adjustment part 135

135c Means for allowing contraction and expansion of the telescoping sections of adjustment part 135

139 Means for modifying the resistance of the lever 140a

140a Means for transferring force from the control handles to the Boom Pole via a Lever

150 Counterweights

152 Means for attaching counterweights

170L Control Handle, Left

170R Control Handle, Right

170La Inner telescoping section for adjusting the vertical length of control handle 170

170Lb Means for connecting, adjusting and locking the adjusting telescoping sections 170La and 170Lb

170Lc Outer telescoping section for adjusting the vertical length of control handle 170

170Ld Means for connecting, adjusting and locking the adjusting telescoping sections 170Lb and 134f

170Ra Inner telescoping section for adjusting the vertical length of control handle 170

170Rb Means for connecting, adjusting and locking the adjusting telescoping sections 170Ra and 170Rc

170Rc Outer telescoping section for adjusting the vertical length of control handle 170

170Rd Means for connecting, adjusting and locking the adjusting telescoping sections 170Rb and 134f

174 Handgrip

180 Support Harness

182 Support Belt

184 Padded Shoulder Straps

Embodiment for Booming from Below

228 Microphone

230 Boom Pole

234 Adjustable means for connecting the boom pole 230 to the control handle 270

234a Inner telescoping section for adjustment part 234

234b Middle telescoping section for adjustment part 234

234c Outer telescoping section for adjustment part 234

234d Means for allowing contraction and expansion of parts 234a and b

234e Means for allowing contraction and expansion of parts 234b and c

240a Means for transferring force from the control handles to the Boom Pole via a Lever

235 Mounting mechanism for lever 240a

250 Counterweights

252 Means for attaching counterweights

270 Control Handle

270a Inner telescoping section for adjusting length of control handle part 270

00] 270b Outer telescoping section for adjusting length of control handle part 270

270c Means for locking the adjusting telescoping sections of control handle part 270

274 Handgrip

03] 280 Support Harness

04] 284 Padded Shoulder Straps

05] One-Handed Small Embodiment

328 Microphone

330 Boom Pole

332 Adjustable means for attaching the boom pole

335 Means for supporting the machine part(s) 340a, 340b and 340c

340 Means for transferring force from the control handles to the Boom Pole via simple machine(s)

340a Means for transferring force via a Gear

340b Means for transferring force via a Gear

340c Means for transferring force via a Chain/Belt

350 Counterweights

352 Means for attaching counterweights

370 Control Handle

374 Adjustable Handgrip with Palm Strap

380 Support Harness

384 Padded Shoulder Straps

### DESCRIPTION OF THE INVENTION

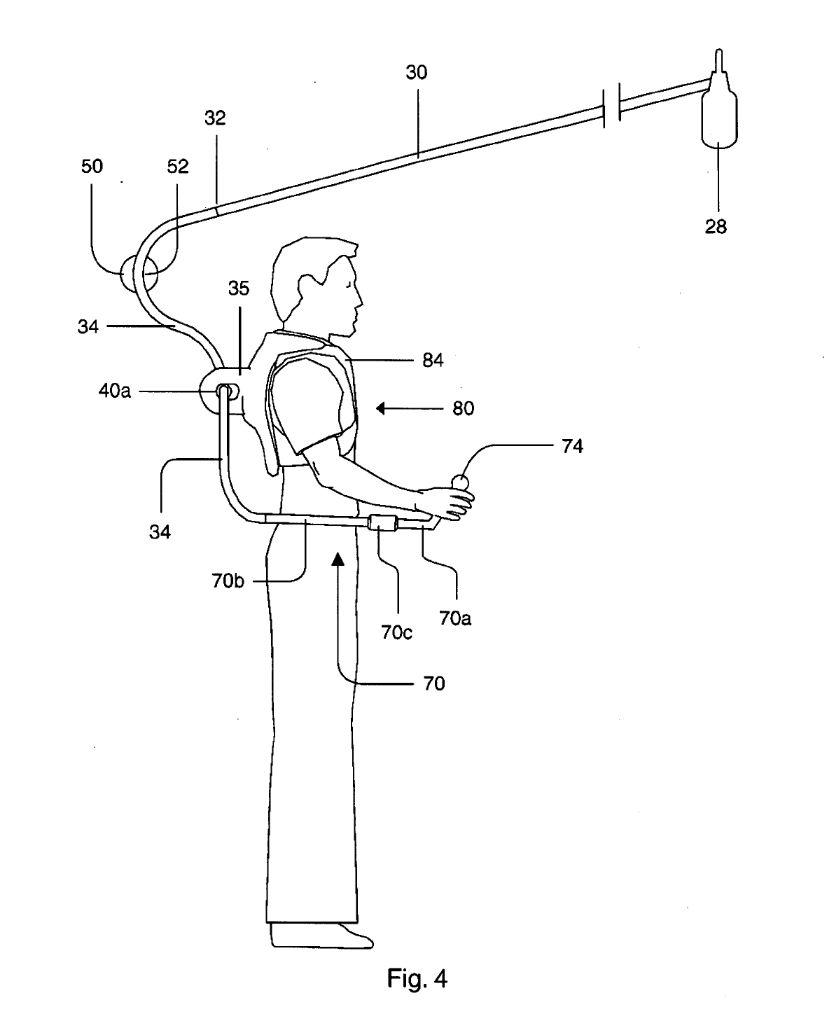

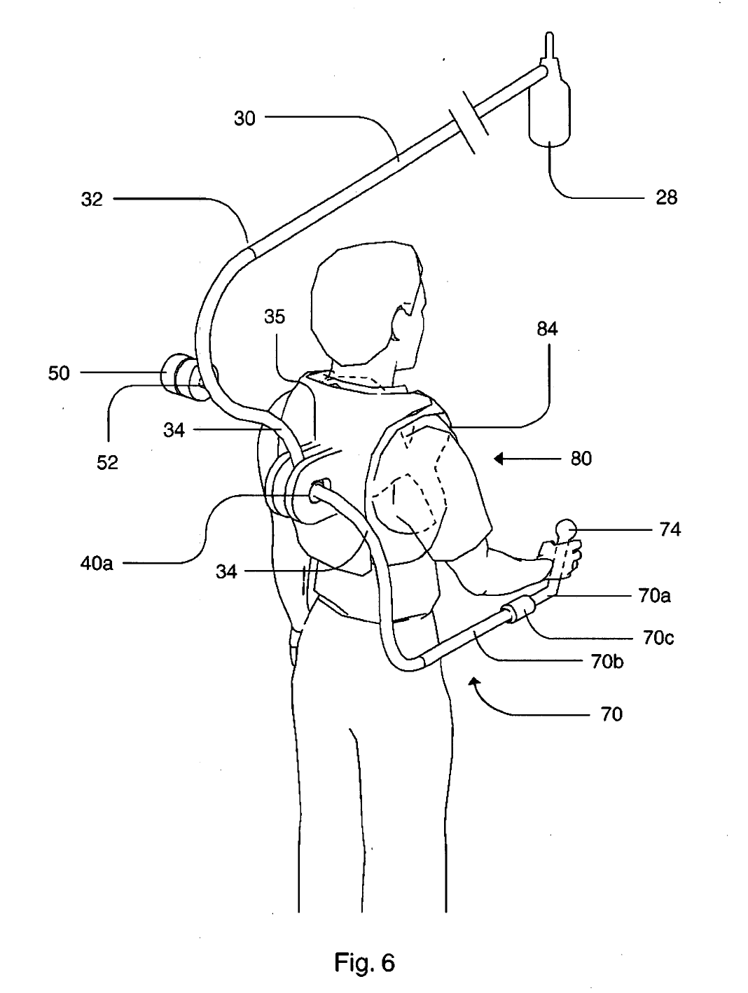

FIGS. 4, 5 and 6 show side elevation, front perspective and rear perspective views of a basic configuration of the invention. A microphone 28 is attached to the far end of a boom pole 30, which is positioned so that it extends its length in front of the operator, perpendicular to their shoulders, and above their head. The boom pole 30 is preferably composed of materials of sufficient strength to support a microphone or other equipment up to 30 feet away. The boom pole 30 can also be manufactured with other means designed to increase strength, such as a triangular or other specially shaped cross section; and manufactured with means for telescoping and articulating its sections. Such modifications will not affect the function of the invention.

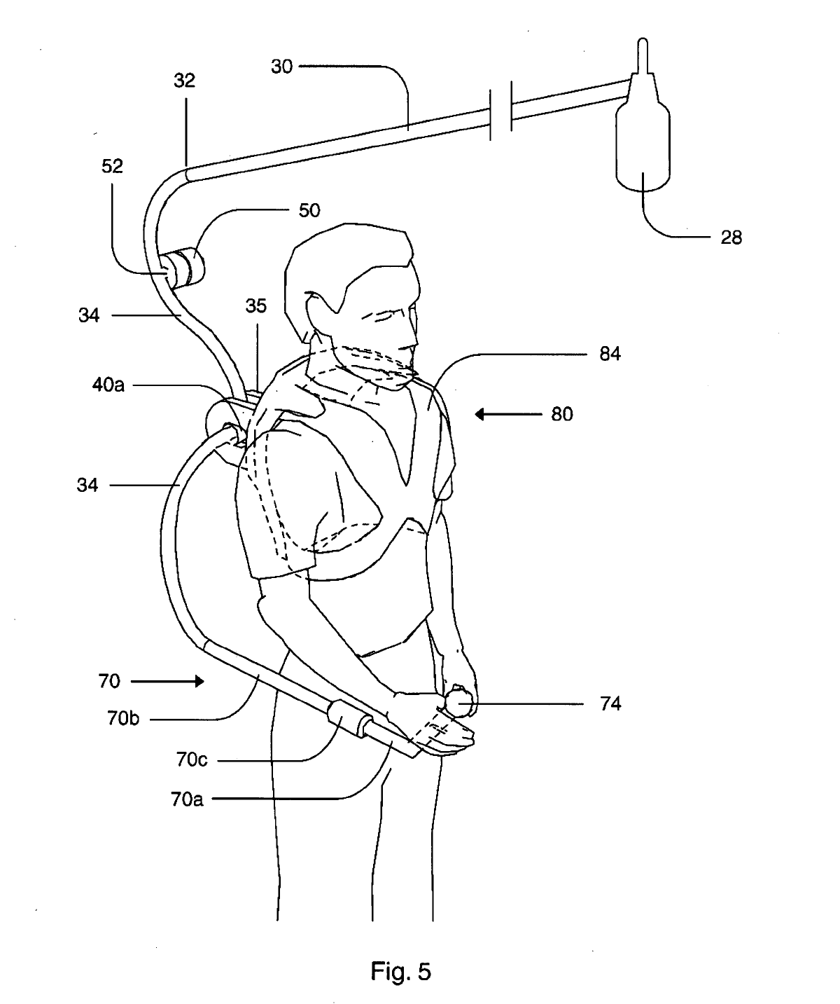

Continuing to reference FIGS. 5, 6 and 7, the boom pole 30 is attached to a connecting rod, bar, molded shape or segment 34 via a means for securely fastening it 32. The connecting segment 34 is a sturdy, curved section, to which the boom pole 30 is securely attached at one end, and to which the control handle 70 is securely attached at the other end, and which is shaped so that it allows freedom of operator movement during operation. Additionally, the connecting segment 34 can be re-assembled to position the control handle 70 for either the left or right hand.

22] Continuing to reference FIGS. 5, 6 and 7, the connecting segment 34 is movably attached to a means for transferring energy, a simple machine which acts as a fulcrum of a lever 40a, which is positioned between the boom arm 30 and the control handle 70. The lever 40a is held in place by a means for supporting it, or mounting mechanism 35. The connecting segment 34 is thus able to move freely in a rotating motion, the axis of which rotation lies perpendicular to the extended length of the boom pole 30. The lever 40a transfers the force applied by the operator to the control handle 70 to the boom arm 30, causing the microphone 28 to move vertically up and down. The lever 40a should ideally include means for adjustable resistance and means to operate noiselessly.

Continuing to reference FIGS. 5, 6 and 7, the mounting mechanism 35 is attached on the back of a wearable harness 80. The mounting mechanism provides a secure anchor for the lever 40a. The harness 80 is held to the operator's torso by a fully adjustable set of padded shoulder straps 84 which can be connected across the operator's sternum in front.

Continuing to reference FIGS. 4, 5 and 6, the control handle 70 consists of a handgrip 74; two hollow cylindrical telescoping sections, an inner section 70a and an outer section 70b; and a locking collar or flange 70c which allows the telescoping sections 70a and 70b to be adjusted to different lengths, and locked in place. The handgrip 74 is padded, angled and shaped to conform to the natural position of the operator's hand. The length of control handle 70 lies parallel to the operator's arm and is attached to the connecting segment 34 behind the elbow.

With continued reference to FIGS. 5, 6 and 7, counterweights 50 are attached to the connecting segment 34 at the point farthest opposite the extended boom pole 30 and microphone 28. Through a means for fastening 52, different weights or combinations of weight can be added and removed.

### Operation of Invention

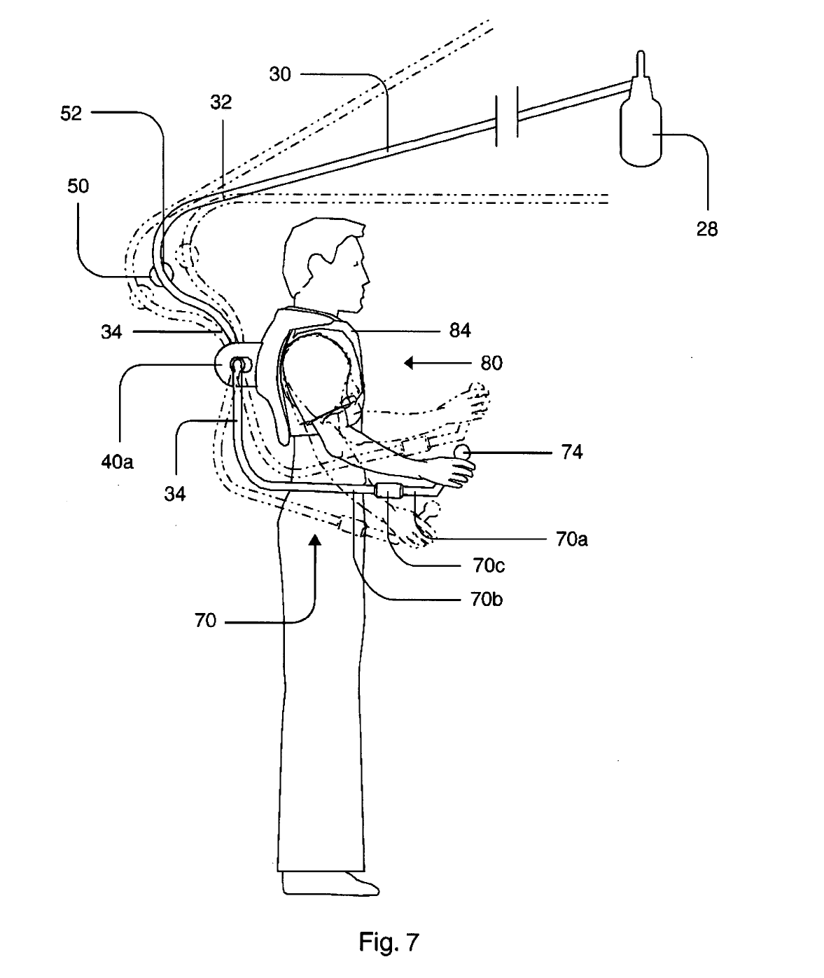

FIG. 7 shows the physics of the lever 40a as applied in general in the invention. The operator wears the support harness 80 with the straps 84 connected in front. The harness supports all of the rest of the apparatus, so a securely adjusted fit is recommended. During use, the operator will grasp the handgrip 74 with one hand, and raise or lower the boom 30 by applying upward or downward force. The counterweights 50 will take most of the strain away from the operator's arms. Ideally, the counterweights 50 should be attached in a combination that will slightly outweigh the combined weight of the boom 30 and microphone 28. This allows the operator to exert only a small amount of downward force on the control handle 70 to keep the boom 30 still, and only slightly more force to move it. The operator can face toward the subject and scene at all times with their arms lowered below the shoulders, and is able to walk, turn and even sit on a stool while working.

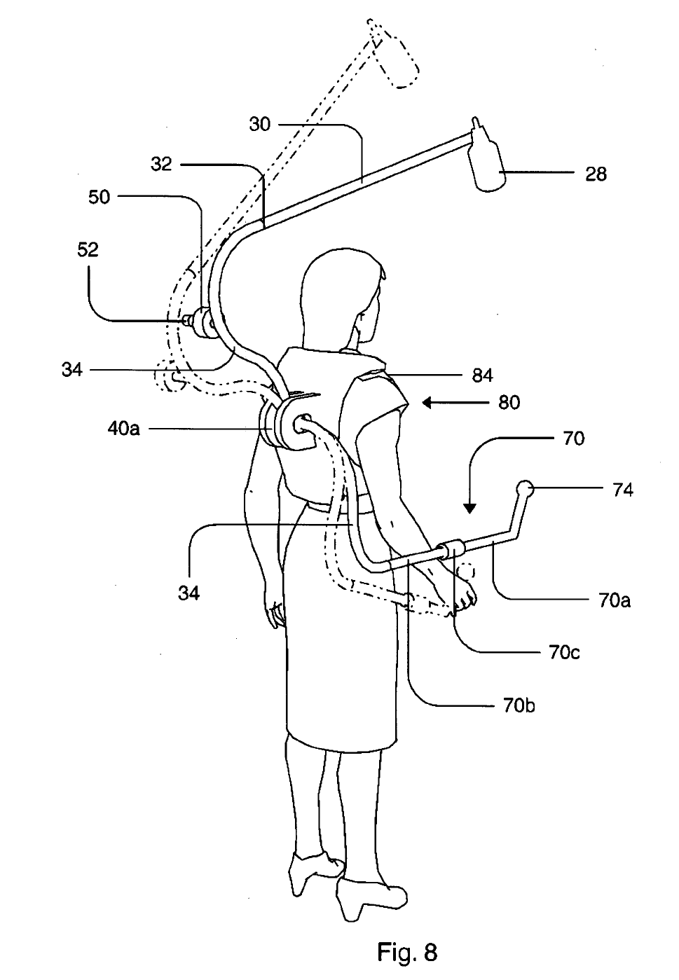

Referring now to FIG. 8, the connecting segment 34 and control handle 70 are adjustable to fit the individual operator and to set the boom pole to a desired initial angle. The control handle 70 is adjustable to fit different users' arm lengths, or preferred angle of the elbow. The operator can also adjust the length of the control handle 70 by rotating the locking flange 70c to release the inner telescoping section 70a, and sliding the inner section 70a closer or further away, or rotating it so that the handgrip 74 is angled to the left or right. The locking flange 70c then locks the inner telescoping section 70a in place.

### Description and Operation of Alternative Embodiments

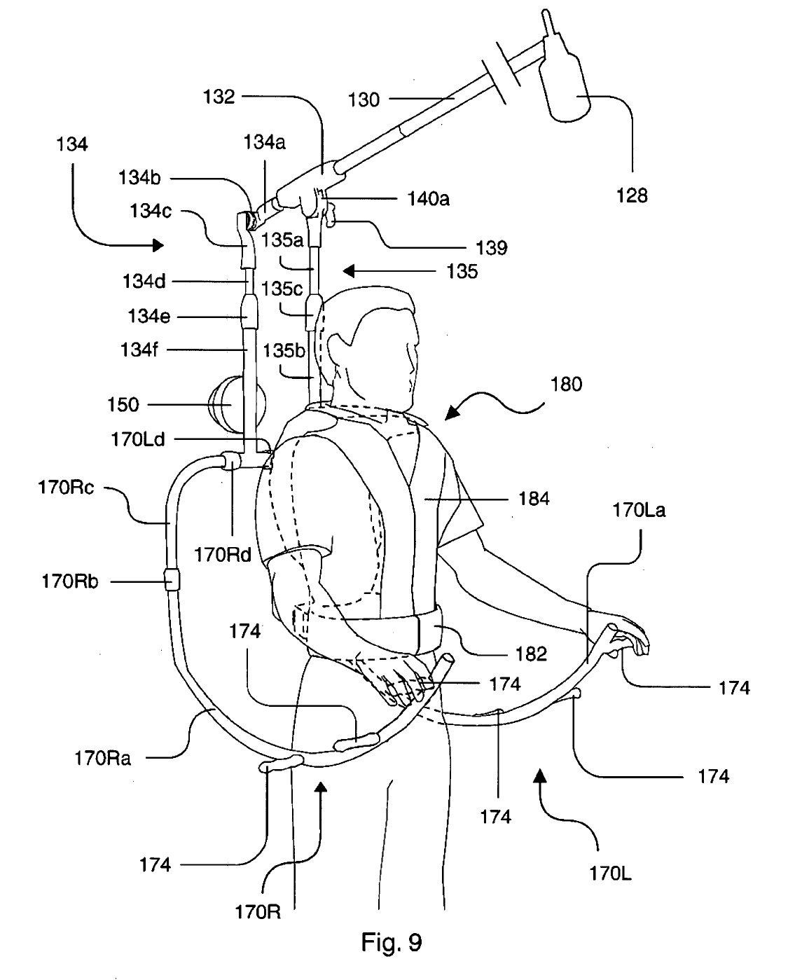

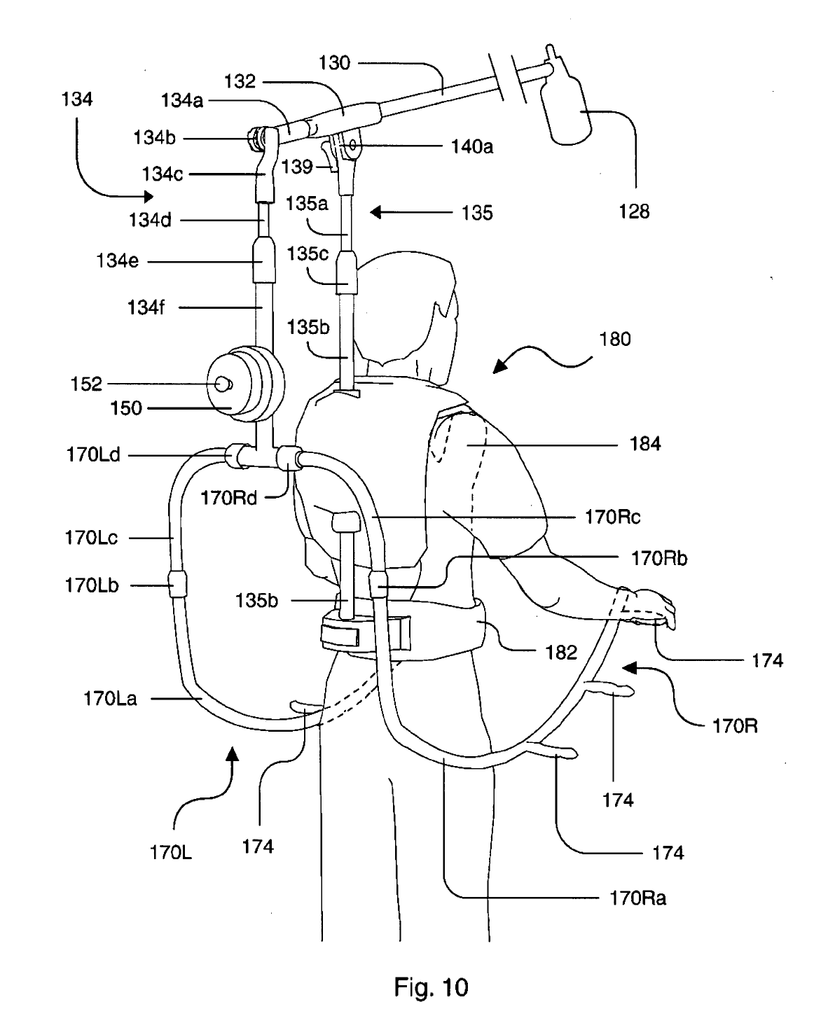

FIGS. 9 and 10 show front perspective and rear perspective views of a heavy duty embodiment of the invention. A microphone 128 is attached to a boom pole 130 which is positioned parallel to the sagittal axis of the operator's body, above the head. The boom pole 130 is preferably composed of materials of sufficient strength to support a microphone or other equipment up to 50 feet away. The boom pole 130 can also be manufactured with other means designed to increase strength, such as a triangular or other specially shaped cross section; and manufactured with means for telescoping and articulating its sections. Such modifications will not affect the function of the invention.

Continuing to reference FIG. 9 and 10, the boom pole 130 is attached to the rest of the invention by a means for mounting it 132, comprised of a rigid mounting box 10 inches long, 2.5 inches wide and 2.5 inches high, and molded so that the boom pole is inserted partly into the box lengthwise to securely affix it. The boom pole mount 132 is further molded on the bottom side with two extruded semicircular pieces to house and attach the lever 140a, and permanently immovably affixed to the upper articulating section 134a of the connecting segment 134 at the back end.

The connecting segment 134 connects the boom pole 130 to the control handles 170R and 170L. The connecting segment 134 is comprised of articulating sections 134a, 134b, and 143c, and telescoping sections 134d, 134e and 134f. The upper articulating section 134a is immovably affixed to the mounting box and lengthwise aligned with it and the boom pole 130. The lower articulating section 134c is immovably attached to the top end of inner telescoping section 134d and lengthwise aligned with it. The two articulating sections 134a and 143c are pivotably connected to each other via a mechanism 134b comprised of two disks, each attached to one of the articulating sections; and having radial triangular grooves which cause them to lock in place when pressed together and rotate freely when pulled apart; and each attached to the other using a means for allowing control of movement and locking. To allow both control handles 170R and 170L and the counterweights 150 to be raised and lowered for the individual operator, the telescoping sections 134d and 134f are connected by a locking collar or flange 134e, which allows them to be adjusted to different lengths, and locked in place.

31] The outer telescoping section 134f includes a crossbar at the bottom, which allows the left and right control handles 170L and 170R to be attached via a means for connecting, adjusting and locking 170Ld and 170Rd. Counterweights 150 of varying sizes can be attached to the rearmost side of outer telescoping section 134f. The counterweights 150 are placed at this point because, with respect to the lever 140a, it is farthest opposite the boom pole 130 and microphone 128. The counterweights 150 are fastened to the outer telescoping section 134f by a means for attaching, locking and releasing 152, so that they can be easily removed and replaced.

32] To control the vertical movement of the boom arm, the operator uses the left control handle 170L and right control handle 170R. They are attached to the crossbar of outer telescoping section 134f respectively by means for connecting, adjusting and locking 170Ld and 170Rd.

33] Each control handle 170L and 170R is comprised of several parts which are designed to position the handgrips 174 so that they are near the operator's hands. Directly attached to part 170Ld is an outer telescoping section 170Lc, which curves downward from horizontal to vertical on the operator's left side. The vertical part of inner telescoping section 170La fits inside the vertical part of outer telescoping section 170Lc. The adjusting telescoping sections 170La and 170Lc are then secured to each other by a means for connecting, adjusting and locking 170Lb.

In the same arrangement, but on the right side of the operator, are the right-handed sections. Directly attached to part 170Rd is an outer telescoping section 170Rc, which curves downward from horizontal to vertical on the operator's right side. The vertical part of inner telescoping section 170Ra fits inside the vertical part of outer telescoping section 170Rc. The adjusting telescoping sections 170Ra and 170Rc are then secured to each other by a means for connecting, adjusting and locking 170Rb. Both sections 170La and 170Ra have three handgrips 174 each, one at the foremost end, one halfway along the length of the curved section, and one exactly between the previous two. The handgrips 174 are six inches long each, padded and molded to fit a hand. The handgrips 174 are cylindrical, with one end rounded and the other attached to the outside edge of the inner telescoping sections 170La and 170Ra so that they point away from the operator.

With continued reference to FIGS. 9 and 10, the means for transferring force from the control handles 170L and 170R to the boom pole 130 is a simple machine, a lever 140a. A resistance controller 139 allows the operator to increase and decrease the friction of the lever machine's 140a moving parts as needed. The lever mechanism 140a is attached to the top of a means for anchoring and supporting it 135.

The machine support 135 is adjustable and comprised of several parts. The lever mechanism 140a is directly supported by and attached to the top end of vertical cylindrical inner telescoping section 135a. This section fits inside the cylinder of outer telescoping section 135b, and can be adjusted vertically by a means for allowing locking, contraction and expansion 135c. The larger, outer telescoping section penetrates and runs through the reinforced back of the support harness 180 and into the reinforced back of the support belt 182.

The support harness 180 is a vest with a reinforced extrusion on the back which encompasses the outer telescoping section 135b, keeping it both vertical and stable, and provides spinal support for the operator. The support harness 180 is held securely on the operator's upper body with padded shoulder straps 184 and additionally by a wide, lightweight support belt 182, both of which fasten in front.

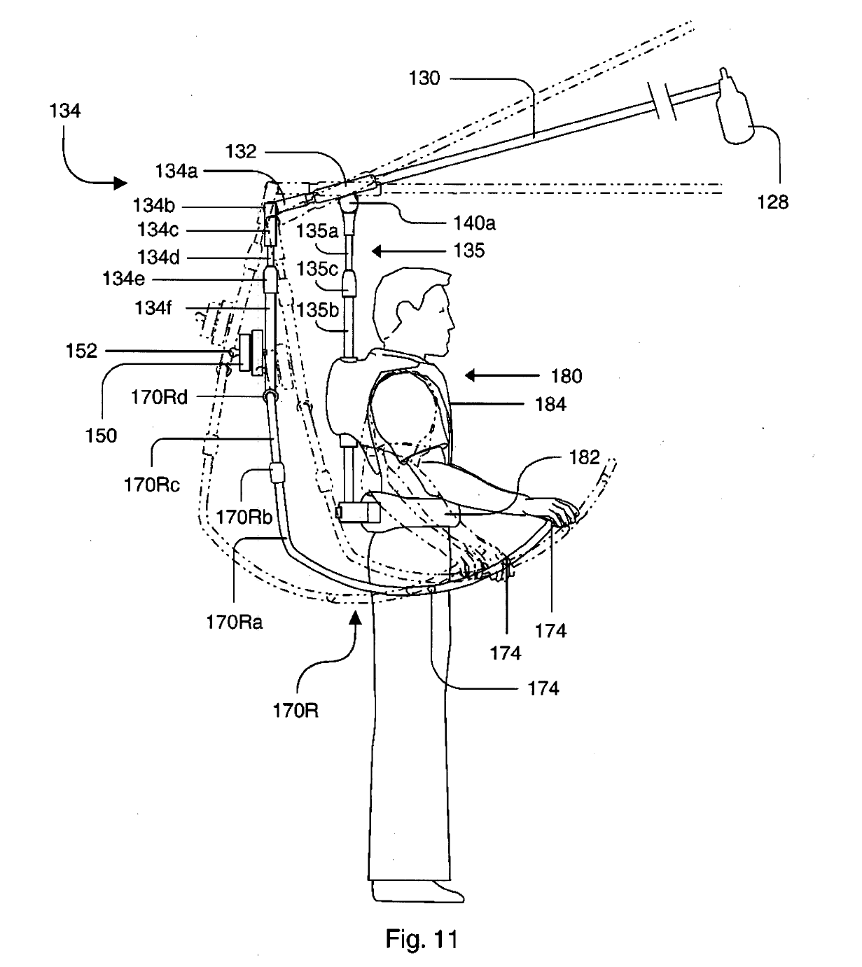

FIG. 11 discloses the operation of the two-handed embodiment. The operator and support harness 180 hold the weight of all of the parts, beginning with the machine support 135. The operator can position his or her hands on any of the six handgrips 174 and push down, or pull up on them. The control handles 170L and 170R move the boom pole 130 and microphone 128 up and down as needed, with the lever mechanism 140a acting as the fulcrum between the effort and the load.

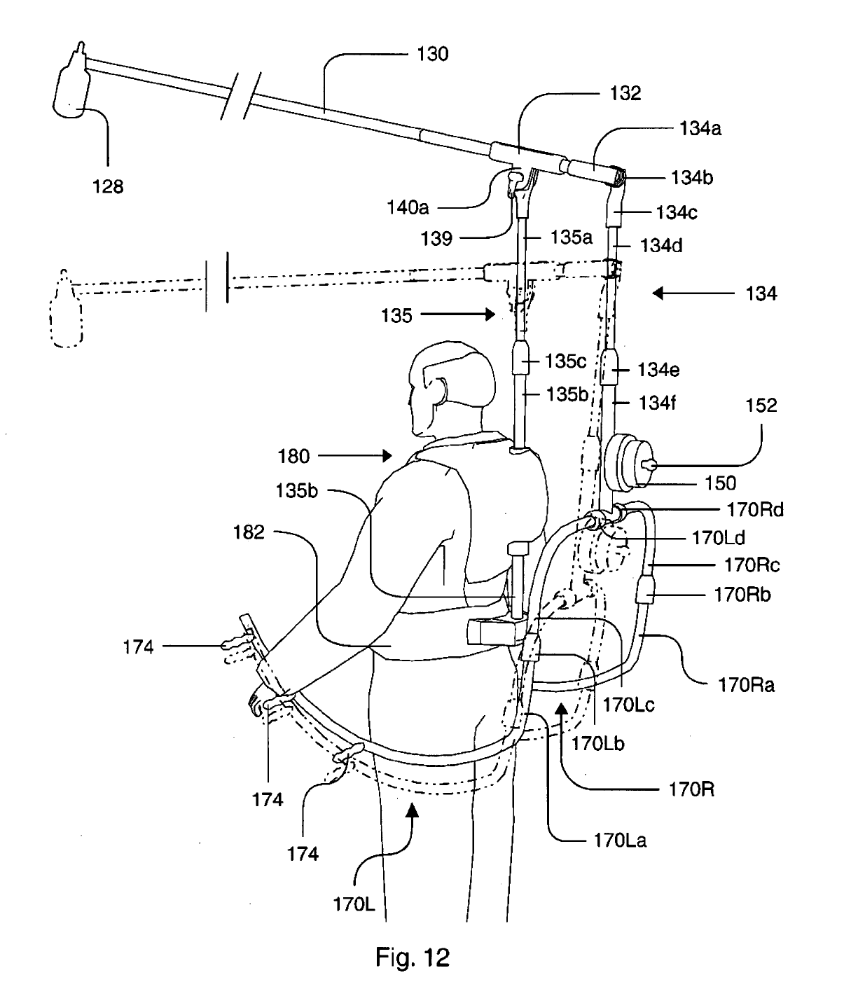

FIG. 12 shows the alternate positions of the adjustable sections of the heavy duty embodiment. The alternate position and angle of the microphone 128 and boom pole 180 is shown as the result of adjustments to the length of the control handles 170L and 170R, the machine support 135, the connecting segment 134, and the support harness 180.

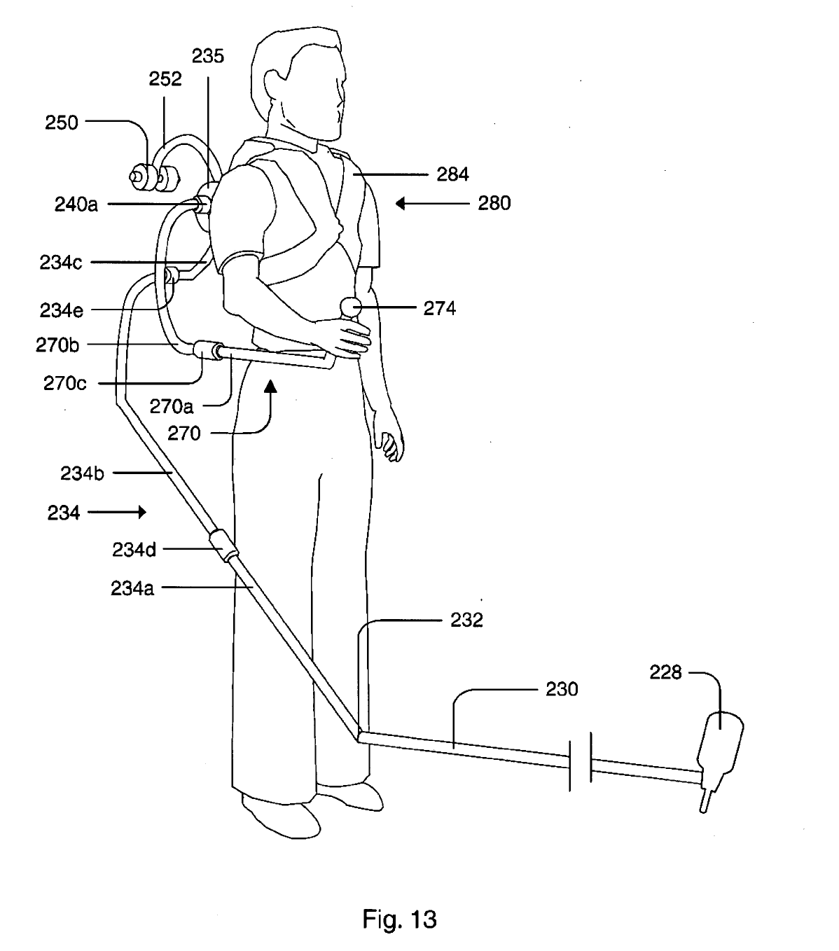

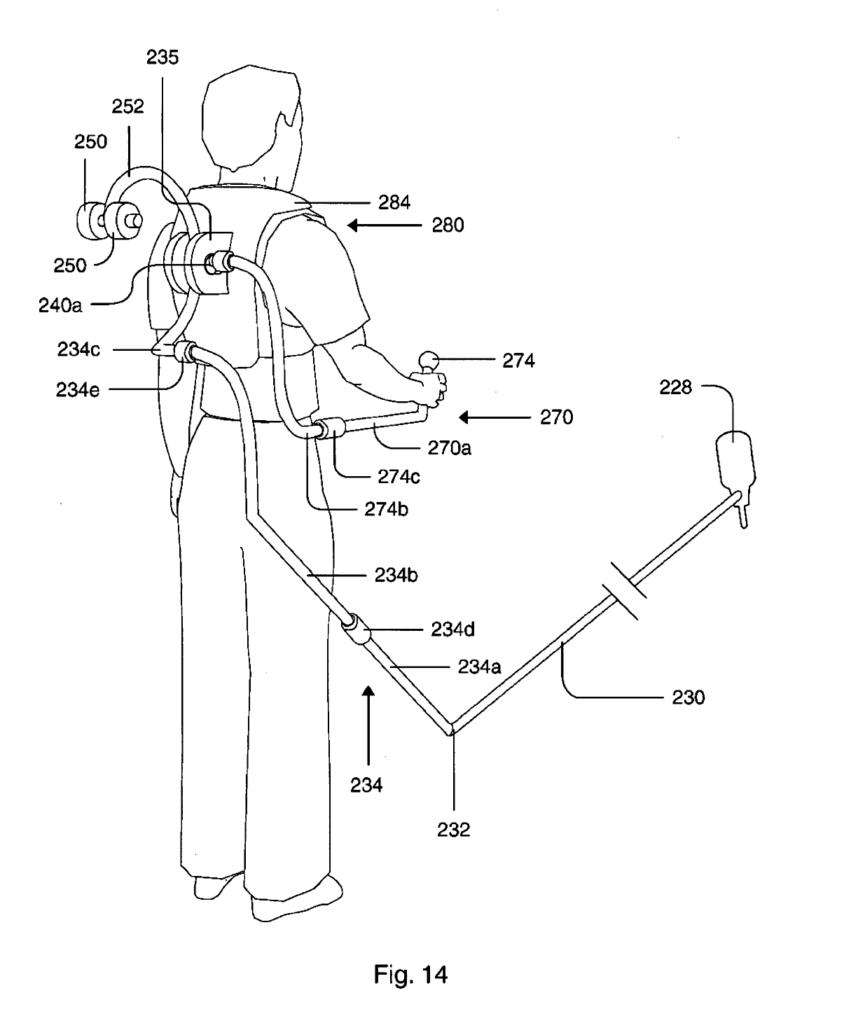

FIGS. 13 and 14 show front perspective and rear perspective views of an alternative embodiment of the invention which positions the boom arm 230 and microphone 228 near the ground. A microphone 228 is attached to a boom pole 230, which is positioned parallel to the sagittal axis of the operator's body, below the waist. Like the basic embodiment, the boom pole 230 is preferably composed of materials of sufficient strength to support a microphone or other equipment up to 30 feet away. The boom pole 230 can also be manufactured with other means designed to increase strength, such as a triangular or other specially shaped cross section; and manufactured with means for telescoping and articulating its sections. Such modifications will not affect the function of the invention.

Continuing to reference FIGS. 13 and 14, the boom pole 230 is attached to a connecting segment 234 via a means for securely fastening it 232. The connecting segment 234 links the boom arm 230 to the control handle 270. The connecting segment 234 is comprised of five parts. The three telescoping sections are: an inner telescoping section 234a; a middle telescoping section 234b; and an outer telescoping section 234c. A means for allowing locking, contraction and expansion 234d enables the operator to set the length of sections 234a and 234b, and thusly the height of the boom pole 230 from the ground. A horizontally placed means for allowing locking, contraction and expansion 234e enables the operator to set the horizontal position of section 234b relative to section 234c, so that the boom pole 230 allows freedom of operator movement during operation. Additionally, the connecting segment 234 can be reconfigured to position the control handle 270 for either the left or right hand.

Continuing to reference FIGS. 13 and 14, the connecting segment 234 is securely attached to the control handle 270 and the means for attaching counterweights 252. Together, they are all movably attached to a means for transferring energy, a simple machine which acts as a fulcrum of a lever 240a. The connecting segment 234 is thus able to move freely in a rotating motion around the lever 240a, the axis of which rotation lies perpendicular to the extended length of the boom pole 230. The lever 240a transfers the force applied by the operator from the control handle 270 to the boom arm 230, causing the microphone 228 to move up and down.

Continuing to reference FIGS. 13 and 14, the mounting mechanism 235 is attached to the back of a wearable harness 280. The harness 80 is held to the operator's torso by a fully adjustable set of padded shoulder straps 84 which can be connected across the operator's sternum in front.

Continuing to reference FIGS. 13 and 14, the control handle 270 consists of a handgrip 274; an inner hollow cylindrical telescoping section 270a and an outer hollow cylindrical telescoping section 270b; and a locking collar or flange 270c which allows the telescoping sections 270a and 270b to be adjusted to different lengths, and locked in place. The handgrip 274 is padded, angled and shaped to conform to the natural position of the operator's hand. The length of the inner section 270a lies parallel to the operator's arm. The outer telescoping section 270b is curved upward and inward toward the mounting mechanism 235 and angled so that it fits directly into the lever mechanism 240a.

With continued reference to FIGS. 13 and 14, counterweights 250 are attached to a means for fastening them 252, a curved section with a short crossbar at the end, designed to hold the counterweights 250 at a point opposite the weight of the boom pole 230 with respect to the lever 240a. The means for attaching weights 252 allows different types of weights or combinations of weight to be added and removed as needed.

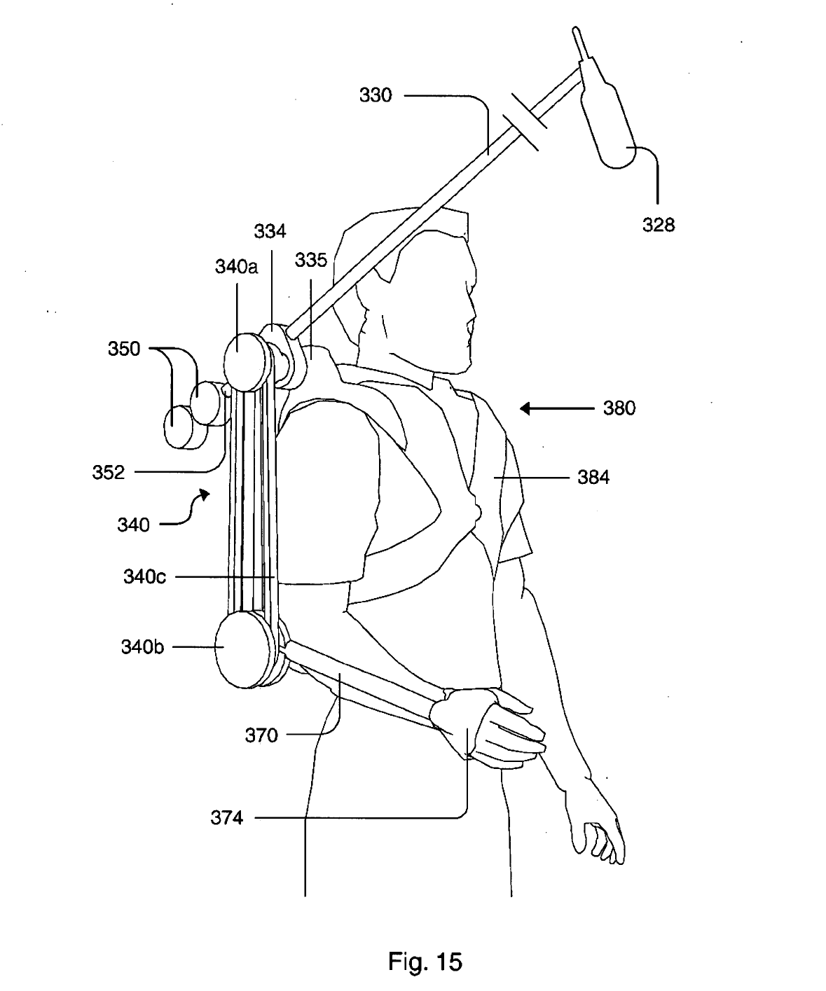

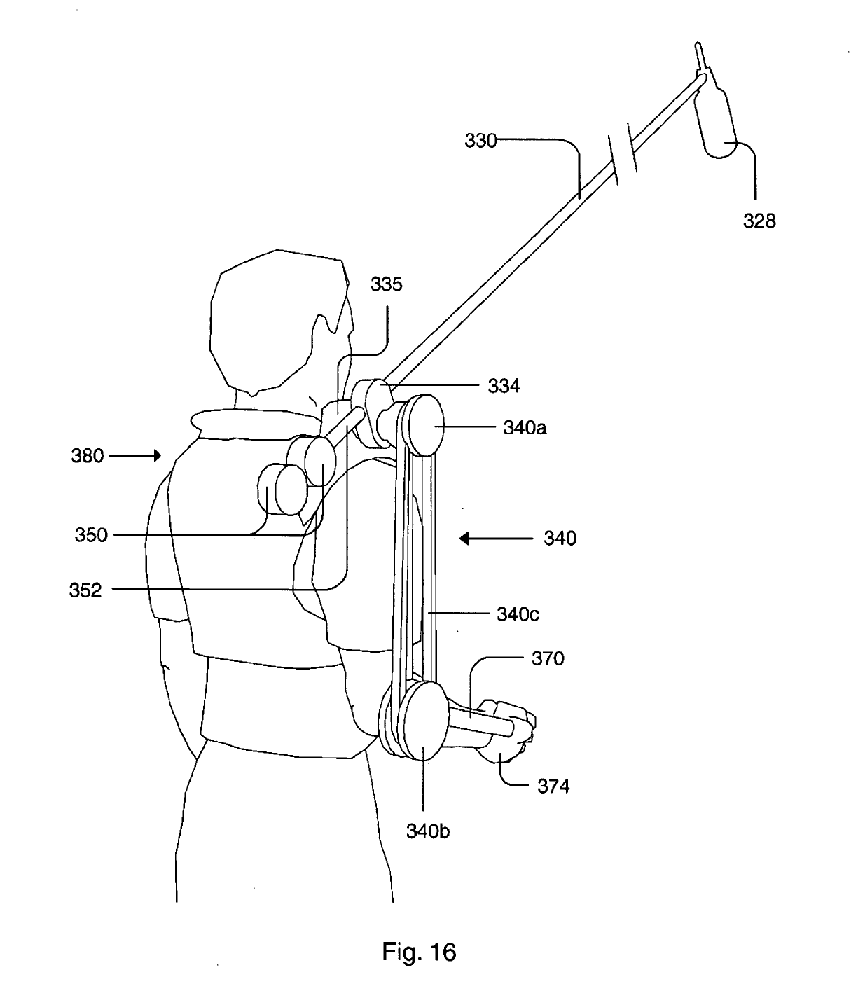

FIGS. 15 and 16 show front perspective and rear perspective views of a light duty configuration of the invention. A small microphone 328 is attached to a boom pole 330 which is positioned parallel to the sagittal axis of the operator's body, above the head. The boom pole 330 for this light duty embodiment can be up to 15 feet long. The boom pole 330 is preferably composed of lightweight materials of sufficient strength to support a microphone or other equipment up to 15 feet away. The boom pole 330 can also be manufactured with other means designed to increase strength, such as a triangular or other specially shaped cross section; and manufactured with means for telescoping and articulating its sections. Such modifications will not affect the function of the invention.

Continuing to reference FIGS. 15 and 16, the boom pole 330 is attached to the rest of the invention by adjustable means for mounting it 334. The boom pole 330 is attached to the front side of mounting segment 334, and the means for attaching weights 352 is attached to the back. The counterweights 350 are then attached at a point opposite the boom pole with respect to the axis of rotation of mounting segment 334. The mounting segment 334 is also attached to the top gear 340a and rotates with it.

The means for transferring force 340 from the operator to the boom pole is accomplished in this embodiment by a combination of two gears 340a and 340b, and a belt 340c. This machine is secured to the support harness 380 by a molded means for supporting the machine part 340, which sits on the operator's shoulder and provides the anchor for machine 340. It also extends through the mounting segment 334 to support gear 340a, then downward to support gear 340c.

With further reference to FIGS. 15 and 16, the lower gear 340c is positioned so that its axis of rotation is concentric with the elbow joint of the operator and parallel to the rotational axis of gear 340a. The control handle 370 is a simple cylindrical strut connected at one end to the radius of lower gear 340C and at the other end to a soft molded handgrip 374. The handgrip 374 includes a palm strap to fasten it around the operator's hand. During use, the operator does not need to grasp the handgrip, and can relax the fingers. The operator will move the boom pole by bending and straightening the elbow. The angle of the control handle can be pre-set to fit the operator's needs, so that the elbow is moved in an ergonomically correct range.

The means for supporting the machine parts 335 sits permanently on one of the padded shoulder straps 384 of the support harness 380. The support harness is worn on the operator's upper body, and fastens in the front to secure the entire device.

### Conclusions, Ramifications and Scope of Invention

This invention, which began with consideration of human factors, results in reduced operator fatigue, discomfort and injury. Users of this ergonomic boom pole support apparatus will experience improvement in occupational health and safety.

What is claimed is:

1. An ergonomic support and control apparatus for boom pole operation comprising:
a. a control handle or handles that can be gripped and moved by the operator's hand(s),
b. a boom pole, or means to securely mount a pre-existing boom pole,
c. means for rigidly connecting the boom bole to the control handles,
d. a means for pivoting, which acts as the fulcrum of a lever, allowing rotation of the control handles and boom pole,
e. a harness, worn by the operator, which supports the entire apparatus and securely anchors the said pivoting means,
whereby the components are arranged and connected so as to constitute the application of a simple machine to convey work energy via Newton's Third Law of Motion, transferring the force exerted by the operator from the control handle(s) into the motion of the boom pole, allowing control of the movement of the boom pole, and so that the operator makes use of it with his or her head, arms and hands in an ergonomically correct position, with the hands and arms down below shoulder level, the upper arms within 45 degrees of the sides of the body, the elbows bent less than 90 degrees, and the head facing forward during operation.

2. The apparatus of claim 1 wherein the said means for pivoting the boom pole is replaced by a means for transferring force applied to the control handles into motion of the boom pole, which employs a wheel and axle, a gear, a chain or belt, ball-and-socket joint or pulley.

3. The apparatus of claim 2 wherein the said means for transferring force consists of a combination or system of said simple machines.
